(19) United States
(12) Patent Application Publication
(10) Pub. No.: US 2026/0101005 A1
(43) Pub. Date: Apr. 9, 2026

(54) SYSTEMS AND METHODS FOR INTELLIGENT HANDLING OF INBOUND CALLS

(71) Applicant: Wells Fargo Bank, N.A., San Francisco, CA (US)

(72) Inventors: John Andrew Chuprevich, Davidson, NC (US); Swarup Pogalur, San Ramon, CA (US); Christopher Gaston Seagram, Addison, TX (US); Matthew N. Wheeler, Charlotte, NC (US); Alexander Wittkowski, San Francisco, CA (US)

(21) Appl. No.: 18/906,771

(22) Filed: Oct. 4, 2024

(51) Int. Cl. H04M 3/51; G06Q 30/015; H04M 3/42; H04M 3/523

(52) U.S. Cl. CPC H04M 3/5191; H04M 3/42221; H04M 3/5175; H04M 3/5235; G06Q 30/015; H04M 2201/405; H04M 2203/402

(57) ABSTRACT

Systems, apparatuses, methods, and computer program products are disclosed for handling an inbound call. An example method includes determining an active inbound call session with a user device associated with a user and determining a caller inquiry from a user statement received from the user over a voice channel. The example method further includes determining whether a digital channel interaction is capable of resolving the caller inquiry and in an instance in which the caller inquiry is resolvable by the digital channel interaction, generating contextual conversation data based on the caller inquiry. The example method further includes providing the contextual conversation data to the user device over a digital channel and causing the call status of the active inbound call session to remain unassigned.

### BACKGROUND

Call centers may receive inbound calls from users who wish to receive assistance with various user inquiries. However, users may be placed on hold for significant periods of time depending on the current call volume, which can lead to user frustration.

### BRIEF SUMMARY

Users may call into call centers to receive assistance with various user inquiries. While the call center may direct the user to an agent who may help resolve their user inquiry, call centers have numerous drawbacks. Call centers oftentimes require a user to navigate through a call center menu, which can be confusing and/or frustrating for the user. Additionally, once the user has successfully navigated through a call center menu, the user may be placed on hold for an extended period of time, which can be frustrating for the user.

Notably, call centers may also have high operational costs, including high costs associated with large network bandwidth usage to ensure real-time data transmission as well high costs associated with recruiting and training agents. Additionally, call centers oftentimes experience high agent turnover due to the nature of the job, which leads to increased recruitment and training costs and thereby compounds the already operating cost expenses. Furthermore, it is difficult to ensure a consistent quality across all interactions with call center agents, which can result in varied user experiences. Thus, sole reliance on call centers is computationally inefficient, resource intensive, and fails to provide a consistent user experience.

Although call center agents are capable of resolving user inquiries, users may resolve certain user inquiries using other means, such as by using a digital channel. In particular, certain user inquiries may be resolvable within a mobile application. However, users may be unaware that such an alternative exists or may be unsure of whether a user inquiry is resolvable over the digital channel. This may result in the user calling into the call center to resolve such a user inquiry, which contributes to high call volumes, increased wait times, and consumes network bandwidth.

The inherent blind spots and limitations associated with handling an inbound call presents a technical problem. A need exists for a solution that (i) determines whether a cross-channel interaction session may resolve a user inquiry for an active inbound call session and (ii) uses the digital channel to resolve the user inquiry. Example embodiments provide a technical solution to this technical problem because example embodiments determine whether the user device associated with the active inbound call session (e.g., the user device that performed the inbound call) is eligible for the cross-channel interaction session. Additionally, example embodiments further determine a caller inquiry and determine whether the caller inquiry is capable of being resolved over the digital channel. If the user device is eligible for the cross-channel interaction session and the digital channel is capable of resolving the caller inquiry, example embodiments may generate responsive contextual conversation data that may be provided over the digital channel to resolve the caller inquiry. Additionally, the call status of the active inbound call session may remain unassigned to enable the user to resolve the user inquiry without being routed to an agent. Once the caller inquiry is resolved, example embodiments may cause the active inbound call session to be terminated. In doing so, users may resolve their user inquiries over a digital communication channel without requiring agent intervention, thereby leading to decreased call wait times, conservation of network bandwidth, and a more streamlined and consistent user experience.

Example embodiments described herein may further monitor a user activity level to infer whether the user is able to successfully engage with the provided contextual conversation data. If the user activity level fails to satisfy engagement requirements, the active inbound call session may be routed and assigned to an agent. In doing so, example embodiments provide for a flexible and responsive system that ensures that the user inquiry can be resolved in a timely manner. Furthermore, even in an instance in which the active inbound call session is assigned and routed to an agent, example embodiments described herein may leverage the cross-channel interaction session to provide for a unique user experience by enabling the user to interact with the agent over both the voice channel and over the digital channel. Use of such a digital channel may provide for enhanced security, such as when the user may need to provide sensitive user information to the agent. Thus, the cross-channel interaction session may allow for a streamlined and unified user experience that enables users, particularly users who prefer to speak to a human agent, to speak with an agent over the voice channel while also receiving the security benefit provided by transmitting sensitive data over the digital channel.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to intelligently handle an inbound call.

FIG. 2 illustrates a schematic block diagram of example circuitry embodying a system device that may perform various operations in accordance with some example embodiments described herein.

FIG. 3 illustrates a schematic block diagram of example circuitry embodying a user device and/or an agent device that may perform various operations in accordance with some example embodiments described herein.

FIG. 4 illustrates an example flowchart for handling an active inbound call session with a user device, in accordance with some example embodiments described herein.

FIG. 5 illustrates an example flowchart for determining a caller inquiry from a user statement, in accordance with some example embodiments described herein.

FIG. 6 illustrates an example flowchart for providing updated contextual conversation data, in accordance with some example embodiments described herein.

FIG. 7 illustrates an example flowchart for monitoring whether a user has successfully resolved the caller inquiry, in accordance with some example embodiments described herein.

FIGS. 8A and 8B illustrate swim lane diagrams with example operations that may be performed by components of the environment depicted in FIG. 1, in accordance with some example embodiments described herein.

FIG. 9 illustrates an example user interface for a user interaction over a digital channel during a cross-channel interaction session, in accordance some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

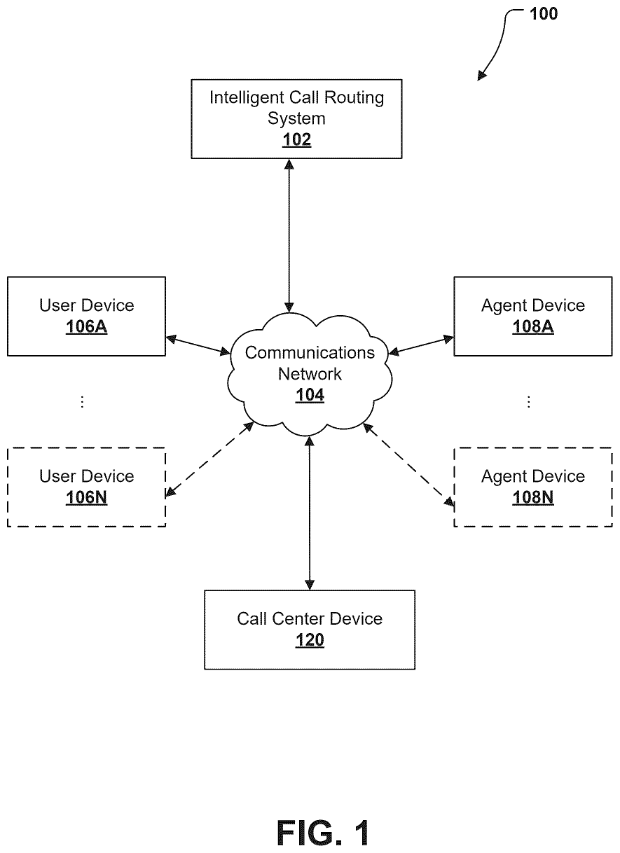

Example embodiments described herein may be implemented using any of a variety of computing devices or servers. To this end, FIG. 1 illustrates an example environment 100 within which various embodiments may operate. As illustrated, an intelligent call routing system 102 may receive and/or transmit information via communications network 104 (e.g., the Internet) with any number of other devices, such as one or more of user devices 106A-106N and/or agent devices 108A-108N.

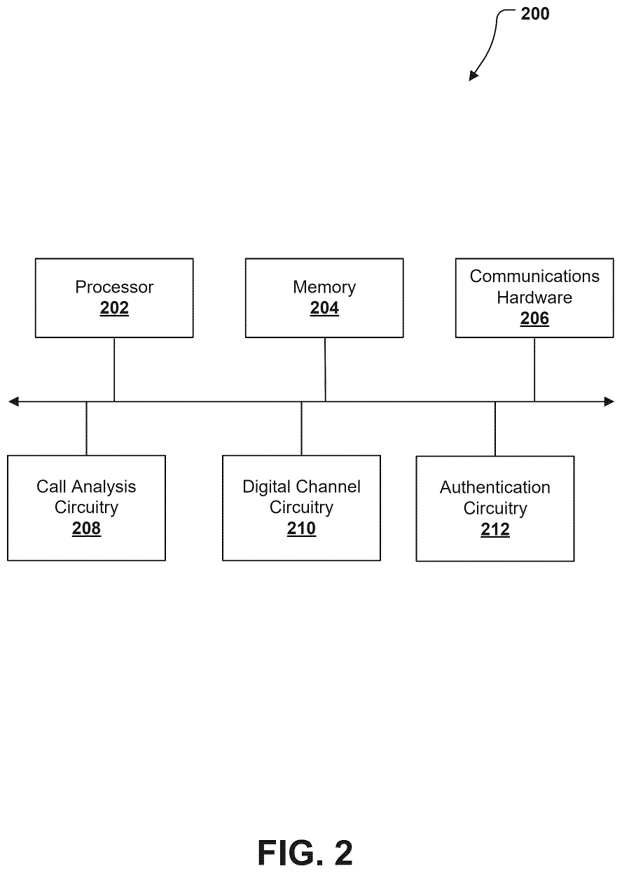

The intelligent call routing system 102 may be implemented as one or more computing devices or servers, which may be composed of a series of components. Particular components of the intelligent call routing system 102 are described in greater detail below with reference to apparatus 200 in connection with FIG. 2.

In some embodiments, the intelligent call routing system 102 further includes a storage device that comprises a distinct component from other components of the intelligent call routing system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the intelligent call routing system 102. The storage device may store information relied upon during operation of the intelligent call routing system 102, such as data and documents to be analyzed using the intelligent call routing system 102 or the like. In addition, the storage device may store control signals, device characteristics, and access credentials enabling interaction between the intelligent call routing system 102 and one or more of the user devices 106A-106N and/or agent devices 108A-108N.

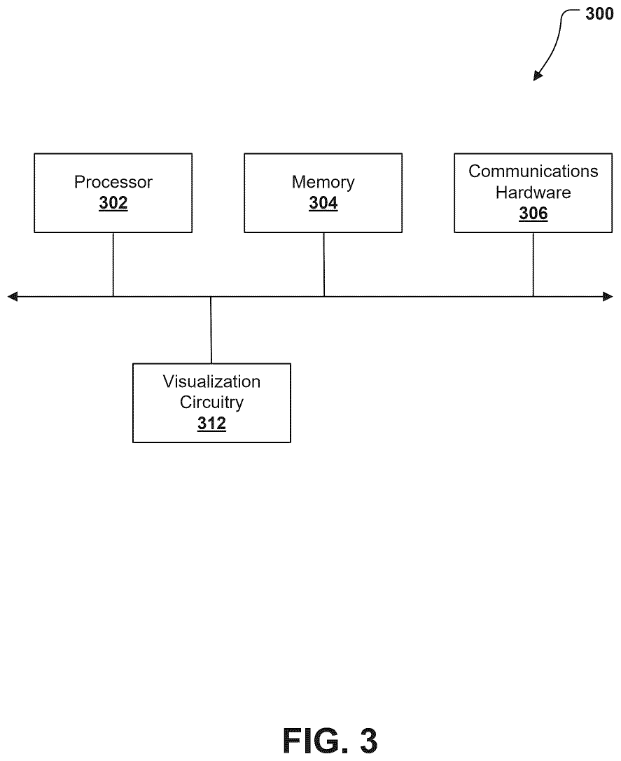

The one or more user devices 106A-106N and the one or more agent devices 108A-108N may be embodied by any computing devices known in the art. The one or more user devices 106A-106N and the one or more agent devices 108A-108N need not themselves be independent devices but may be peripheral devices communicatively coupled to other computing devices. In some embodiments, a user device (e.g., any one of user devices 106A-106N) may be associated with a user who is associated with a user account maintained by the intelligent call routing system 102 (e.g., a customer). In some embodiments, an agent device (e.g., any one of agent devices 108A-108N) may be associated with an agent who is an authorized user associated with the intelligent call routing system 102 (e.g., an employee of the entity associated with the intelligent call routing system 102) and/or the call center device 120 (e.g., call center agents). Particular components of the user device (e.g., any one or user devices 106A-106N) and/or the agent device (e.g., any one of agent devices 108A-108N) are described in greater detail below with reference to apparatus 300 in connection with FIG. 3.

The call center device 120 may be an automatic call distributor (ACD) that is associated with the intelligent call routing system 102. In some embodiments, the call center device 120 may be further configured as an intelligent voice response (IVR) system that can receive and/or process voice commands or keypad input commands received from connected user devices (e.g., any one of user device 106A-106N).

Although FIG. 1 illustrates an environment and implementation in which the intelligent call routing system 102 interacts indirectly with a user via one or more of user devices 106A-106N and/or agent devices 108A-108N, in some embodiments users may directly interact with the intelligent call routing system 102 (e.g., via communications hardware of the intelligent call routing system 102), in which case a separate user device 106A-106N and/or agent device 108A-108N may not be utilized. Whether by way of direct interaction or indirect interaction via another device, a user may communicate with, operate, control, modify, or otherwise interact with the intelligent call routing system 102 to perform the various functions and achieve the various benefits described herein.

### Example Implementing Apparatuses

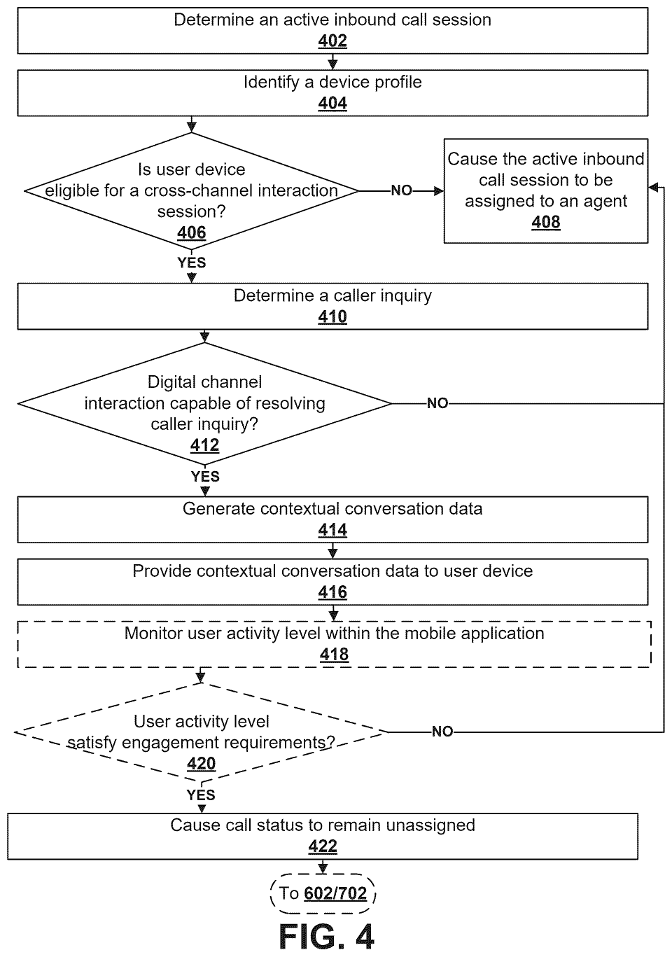

The intelligent call routing system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-7. As illustrated in FIG. 2, the apparatus 200 may include processor 202, memory 204, communications hardware 206, call analysis circuitry 208, digital channel circuitry 210, and authentication circuitry 212, each of which will be described in greater detail below.

The processor 202 (and/or co-processor or any other processor assisting or otherwise associated with the processor) may be in communication with the memory 204 via a bus for passing information amongst components of the apparatus 200. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor 202. In some cases, the processor 202 may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, software application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises call analysis circuitry 208 that may be configured to determine an active inbound call session with a user device, determine a caller inquiry from a user statement, determine whether a digital channel is capable of resolving a caller inquiry, and causing the active inbound call session to remain unassigned. The call analysis circuitry 208 may further be configured to cause the active inbound call session to be terminated, cause the active inbound call session to be assigned to an agent, determine a device profile associated with a device phone number, transform a raw user statement into the user statement, and/or the like. The call analysis circuitry 208 may utilize processor 202, memory 204, or any other hardware component included in the apparatus 200 to perform these operations, as described in connection with FIGS. 4-7 below. The call analysis circuitry 208 may further utilize communications hardware 206 to gather data from a variety of sources (e.g., any one of user devices 106A-106N, agent devices 108A-108N, call center device 120, as shown in FIG. 1), and/or exchange data with a user and/or agent.

In addition, the apparatus 200 further comprises digital channel circuitry 210 that may be configured to generate contextual conversation data, update contextual conversation data, monitor whether the user has successfully resolved the caller inquiry, monitor a user activity level within the mobile application, and/or the like. The digital channel circuitry 210 may utilize processor 202, memory 204, or any other hardware component included in the apparatus 200 to perform these operations, as described in connection with FIGS. 4-7 below. The call analysis circuitry 208 may further utilize communications hardware 206 to gather data from a variety of sources (e.g., any one of user devices 106A-106N, agent devices 108A-108N, call center device 120, as shown in FIG. 1), and/or exchange data with a user and/or agent.

Further, the apparatus 200 further comprises authentication circuitry 212 that may be configured to authenticate a user and/or logon request and/or the like. The authentication circuitry 212 may utilize processor 202, memory 204, or any other hardware component included in the apparatus 200 to perform these operations, as described in connection with FIGS. 4-7 below. The authentication circuitry 212 may further utilize communications hardware 206 to gather data from a variety of sources (e.g., any one of user devices 106A-106N, agent devices 108A-108N, call center device 120, as shown in FIG. 1), and/or exchange data with a user and/or agent.

Although components 202-212 are described in part using functional language, it will be understood that the particular implementations necessarily include the use of particular hardware. It should also be understood that certain of these components 202-212 may include similar or common hardware. For example, the call analysis circuitry 208, digital channel circuitry 210, and authentication circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the call analysis circuitry 208, digital channel circuitry 210, and authentication circuitry 212 may leverage processor 202, memory 204, or communications hardware 206 as described above, it will be understood that any of call analysis circuitry 208, digital channel circuitry 210, and authentication circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that call analysis circuitry 208, digital channel circuitry 210, and authentication circuitry 212 comprise particular machinery designed for performing the functions described herein in connection with such elements of apparatus 200.

As illustrated in FIG. 3, an apparatus 300 is shown that represents an example user device (e.g., any of user devices 106A-106N). The apparatus 300 includes processor 302, memory 304, and communications hardware 306, each of which is configured to be similar to the similarly named components described above in connection with FIG. 2. However, the apparatus 300 may also include visualization circuitry 312, which includes hardware components configured to display received data, notifications, messages, and/or the like. In some embodiments, visualization circuitry 312 may cause data from received communications (e.g., contextual conversation data or the like) to be displayed in a mobile application and render various elements in the mobile application environment. The visualization circuitry 312 may utilize processor 302, memory 304, or any other hardware component included in the apparatus 300 to perform these operations, as described in connection with FIGS. 4-7 below. The visualization circuitry 312 may further utilize communications hardware 306 to gather data from a variety of sources (e.g., intelligent call routing system 102, call center device 120, and/or agent devices 108A-108N, as shown in FIG. 1), and/or exchange data with a user or agent.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Operations

Turning to FIGS. 4-7, example flowcharts are illustrated that contain example operations implemented by example embodiments described herein. The operations illustrated in FIGS. 4-7 may, for example, be performed by the intelligent call routing system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, call analysis circuitry 208, digital channel circuitry 210, authentication circuitry 212, and/or any combination thereof. It will be understood that user interaction with the intelligent call routing system 102 may occur directly via communications hardware 206, or may instead be facilitated by a separate user device (e.g., any one of user device 106A-106N) and/or an agent device (e.g., any one of agent devices 108A-108N), as shown in FIG. 1, and which may have similar or equivalent physical componentry facilitating such user interaction.

Turning first to FIG. 4, example operations are shown for handling a call request.

As shown by operation 402, the apparatus 200 includes means, such as communications hardware 206, call analysis circuitry 208, or the like, for determining an active inbound call session. An active inbound call session may be initiated by a user device, such as user device 106A and the incoming call may be directed to the call center device 120. The call center device 120 may be an ACD that is configured to receive incoming calls from user devices (e.g., any one of user devices 106A-106N) and route them to an appropriate agent device (e.g., any one of agent devices 108A-108N). In some embodiments, the communications hardware 206 may receive an indication, notification, alert, or the like from the call center device 120 in response to the call center device 120 receiving an incoming call from user device 106A. The notification may include incoming call details, such as the device phone number of the user device performing the incoming call as well as pertinent incoming call details, such as a call duration, call status (assigned or unassigned), call connection status (connected or disconnected, active or inactive, or the like), etc. The communications hardware 206 may provide a notification to the call analysis circuitry 208 that is indicative of receipt of the notification from the call center device 120. The call analysis circuitry 208 may then determine an active inbound call session in response to receipt of this notification from the communications hardware. The active inbound call session may be associated with a device phone number for the user device 106A and further, may be associated with other pertinent call details, such as the duration of the call, the call connection status, the call status, and/or the like.

Additionally, or alternatively, the communications hardware 206 may be configured to monitor for incoming calls received by the call center device 120. In response to detecting an incoming call from the user device 106A, the communications hardware 206 may provide the notification to the call analysis circuitry 208 and in turn, the call analysis circuitry 208 may determine the active inbound call session.

The active inbound call session may be associated user device 106A, the device performing the inbound call, and the user device 106A may be associated with a particular user, such as a customer or potential customer affiliated with an entity that operates apparatus 200. Additionally, as described above, the active inbound call session may be associated with a call status. The call status may be indicative of a current assignment status with respect to an agent for the inbound call. For example, an assigned call status may indicate the inbound call has been assigned to a particular agent device, such as agent device 108A. A call with an assigned call status may currently be speaking with an agent associated with agent device 108A. An unassigned call status may indicate that the inbound call has yet to be assigned to a particular agent device or may be in a queue waiting to speak to an agent associated with agent device 108A. In some embodiments, the active inbound call session may remain unassigned until the user associated with user device 106A has navigated through an IVR menu, an agent device 108A is available, or as described in greater detail below, the call analysis circuitry 208 causes the active inbound call session to be assigned to an agent. Thus, when a user device 106A first connects with the call center device 120 and the call analysis circuitry 208 determines the active inbound call sessions, the call status of the active inbound call session may be associated with an unassigned call status.

Additionally, in some embodiments, the call analysis circuitry 208 may determine an estimated wait time for the user to speak with an agent. In particular, the call analysis circuitry 208 may receive notifications from call center device 120 or may monitor for inbound calls automatically. Thus, the call analysis circuitry 208 may determine an estimated wait time based on the current number of active inbound call sessions associated with call center device 120. In particular, the call analysis circuitry 208 may be configured to use mathematical and/or logical operations to determine an estimated wait time based on comparable historical inbound call session volumes and associated historical wait times.

As shown by operation 404, the apparatus 200 includes means, such as memory 204, call analysis circuitry 208 or the like, for identifying a device profile. The call analysis circuitry 208 may identify a device profile that is associated with the device phone number of the user device 106A. A device profile may correspond to a particular user device, such as user device 106A, and may include relevant user device information. For example, the device profile may include a phone number for the user device, one or more device identifiers (e.g., a MAC address, IP address, IMEI number, phone number, a MEID, a UDID, a hardware identifier, an electronic serial number, or any other identifier that uniquely identifies the particular user device), an associated device trust score, a user device type, an indication or log of when the user device previously accessed an associated user account via an associated mobile application, and/or the like. Additionally, the device profile may include an account activity log that describes the activity of the user device 106A with respect to an associated user account. For example, the account activity log may indicate a timestamp and/or geographic location for logon requests received from the user device 106A, an indication of whether those requests were successfully authenticated or not successfully authenticated, user interactions and/or requests received during an established session, an indication of the established session type (e.g., whether the logon request and established session was performed within a software application, mobile application, or over a web browser).

To identify the device profile, the call analysis circuitry 208 may query an associated memory 204 or a device profile repository for the device phone number associated with the active inbound call session. The call analysis circuitry 208 may identify the device profile if the query returns a match and further, may identify the corresponding device profile from the query results. Thus, the call analysis circuitry 208 may use the device phone number from the active inbound call session to identify a corresponding or matching device phone number included in a device profile and may then identify this device profile for subsequent operations. If the query results or empty or indicate no match is found, the process may proceed to operation 408, which is described in further detail below.

The device profile for user device 106A may be associated with a user account that corresponds to the user. The user account may include other device profiles if the user has user devices other than user device 106A. The user account may include user information (name, a residential and/or mailing address, demographic information, or the like), user financial accounts and associated financial account information, enabled permissions, and/or the like. In some embodiments, the enabled permissions associated with the user account may include a permission of whether the user has enabled, enrolled, or is otherwise registered for receiving communications from apparatus 200 via one or more of their user devices, such as user device 106A. Additionally, or alternatively, this permission may be controlled or set within the individual device profile.

As shown by operation 406, the apparatus 200 includes means, such as memory 204, call analysis circuitry 208 or the like, for determining whether the user device is eligible for a cross-channel interaction session. Once the call analysis circuitry 208 has identified the device profile for the user device 106A, the call analysis circuitry 208 may further determine whether the user device 106A is eligible for a cross-channel interaction session. To do so, the call analysis circuitry 208 may analyze the device profile identified in operation 404 and determine whether the device profile corresponding the user device 106A satisfies cross-channel interaction requirements.

A cross-channel interaction session may correspond to a process where the user device 106A may be engaged or in communication with call center device 120 over a voice channel and apparatus 200 via communications hardware 206 over a digital channel. In particular, the user device 106A may be in communication with the call center device 120 over the voice channel that corresponds to the phone call (e.g., the inbound phone call from the user device 106A). Therefore, the user device 106A has already established a connection over the voice channel by performing the inbound call. The voice channel may be established over any suitable medium, such as over a public switched telephone network (PSTN), a voice over internet protocol (VoIP), a cellular network, a satellite call, a web real-time communication (WebRTC), and/or the like.

The call analysis circuitry 208 may determine whether the user device 106A is further eligible and/or configured for establishing a connection over a digital channel. More particularly, the digital channel may refer to a connection between the communications hardware 206 and a mobile application of the user device 106A. A cross-channel interaction session may allow for the user device 106A to provide data, receive data, or otherwise communicate with apparatus 200 over a voice channel and the digital channel. It will be appreciated that the user device 106A and apparatus 200 are in communication over the voice channel via the call center device 120, which may provide data and/or call information of the call to communications hardware 206. To determine whether the user device 106A is eligible for establishing a digital channel, thereby establishing a cross-channel interaction session, the call analysis circuitry 208 may analyze the device profile and determine whether cross-channel interaction requirements are satisfied. If each requirement of the cross-channel interaction requirements is satisfied, the call analysis circuitry 208 may determine user device 106A is eligible for the cross-channel interaction session. Alternatively, if a requirement of the cross-channel interaction requirements fails to be satisfied, the call analysis circuitry 208 may determine user device 106A is not eligible for the cross-channel interaction session.

In some embodiments, cross-channel interaction requirements may be stored and/or maintained in memory 204 or another storage repository. The cross-channel interaction requirements may define one or more requirements, criteria, conditions, etc. that must be satisfied in order for a cross-channel interaction session to be established. In some embodiments, the cross-channel interaction requirements are preconfigured or set by an authorized agent (e.g., a system administrator, a compliance officer, a manager, or the like). The call analysis circuitry 208 may be configured to access the cross-channel interaction requirements from memory or the storage location and use these cross-channel interaction requirements to determine whether user device 106A is eligible for the cross-channel interaction session.

In some embodiments, the cross-channel interaction requirements may require that user device 106A has previously accessed the user account via an associated mobile application. This requirement may ensure that user device 106A is capable of establishing a connection with apparatus 200 over the digital channel. In some embodiments, the communications hardware 206 may receive a logon request from user device 106A. In order to provide this logon request, user device 106A must have an associated mobile application installed.

As described above, in some embodiments, the device profile for the user device 106A may include an account activity log. The account activity log may indicate a timestamp and/or geographic location for logon requests received from the user device 106A, an indication of whether those requests were successfully authenticated or not successfully authenticated, user interactions and/or requests received during an established session, an indication of the established session type (e.g., whether the logon request and established session was performed within a software application, mobile application, or over a web browser). The call analysis circuitry 208 may use the account activity log from the device profile of user device 106A to determine whether user device 106A has previously accessed the associated user account via the mobile application. If the call analysis circuitry 208 determines the account activity log indicates the user device 106A has previously accessed the user account using the required mobile application, then call analysis circuitry 208 may determine this cross-channel interaction requirement is satisfied. Otherwise, the call analysis circuitry 208 may determine this cross-channel interaction requirement is not satisfied.

In some embodiments, the call analysis circuitry 208 may additionally determine whether the user device 106A has accessed the user account via the mobile application within a predefined time window (e.g., within the past day, week, month, or the like). The call analysis circuitry 208 may determine whether the account activity log in the device profile indicates a timestamp for a successful logon request has occurred within the predefined time window. This cross-channel interaction requirement may ensure that user device 106A is currently configured with the required mobile application. The call analysis circuitry 208 may determine this cross-channel interaction requirement is satisfied if the account activity log indicates or describes a successful logon request has occurred within the predefined time window. Otherwise, the call analysis circuitry 208 may determine this cross-channel interaction requirement is not satisfied.

In some embodiments, the cross-channel interaction requirement may require that the user account and/or device profile includes enabled permissions that the user has enabled, enrolled, or is otherwise registered for receiving communications from apparatus 200 via user device 106A. In some embodiments, the call analysis circuitry 208 may determine whether the identified device profile for user device 106A is indicative of such permissions and/or whether the user profile associated with the device profile is indicative of such permissions. For example, a device profile and/or user account may be associated with a consent to receive communications category. The consent to receive communications category may be indicative of whether the user has opted in to receive communications, such as text messages, push notifications, emails, calls, or the like related to his/her user account and/or on the corresponding user device. By way of particular example, a consent to receive communications category may either be enabled or disabled. The call analysis circuitry 208 may determine whether the consent to receive communications category associated with the user and/or device profile is enabled for the user device 106A. If the call analysis circuitry 208 determines the consent to receive communications category is enabled for user device 106A, the call analysis circuitry 208 may determine this cross-channel interaction requirement is satisfied. Otherwise, the call analysis circuitry 208 may determine the cross-channel interaction requirement is not satisfied.

In some embodiments, the cross-channel interaction requirement may require that user device 106A is associated with a trusted user device status. In some embodiments, the call analysis circuitry 208 may determine whether the user device is associated with a trusted user device status. In some embodiments, the device profile for the user device may include an associated device trust score. A device trust score may be indicative of an inferred amount of trust or confidence that the user device is legitimately associated with or belongs to the user. In some embodiments, the device trust score may be a numerical value that falls within a predefined range. The call analysis circuitry 208 may determine whether user device 106A is associated with a trusted user device status based on the associated device trust score included in the device profile. In particular, in some embodiments, the call analysis circuitry 208 may determine whether the device trust score satisfies a device trust score threshold. If the call analysis circuitry 208 satisfies the device trust score, the call analysis circuitry 208 may determine the cross-channel interaction requirement is satisfied. Otherwise, the call analysis circuitry 208 may determine the cross-channel interaction requirement is not satisfied.

If the user device is not eligible for a cross-channel interaction session, the process proceeds to operation 408. As shown by operation 408, the apparatus 200 includes means, such as communications hardware 206, call analysis circuitry 208 or the like, for causing the active inbound call session to be assigned to an agent. If the call analysis circuitry 208 determines user device 106A is not eligible for the cross-channel interaction session, the call analysis circuitry 208 may cause the active inbound call session to be assigned to an agent. If the user device 106A is determined to fail the cross-channel interactions requirements, this may be indicative that the user device 106A is not configured to establish communication across a digital channel or that the user has opted out or disabled communications with user device 106A necessary to establish communication across a digital channel. Because communication across the digital channel cannot be initiated or prompted by communications hardware 206, the call analysis circuitry 208 may determine that a cross-channel interaction session is not possible for the active inbound call session. Therefore, the active inbound call session can be routed directly to an agent device.

The call analysis circuitry 208 may use communications hardware 206 to provide software executable instructions to the call center device 120 that causes the call center device 120 to assign the inbound call with user device 106A to an agent and/or agent device. If an agent device is not currently available, the call center device 120 may place the inbound call with the user device 106A in an active queue and may connect the user device 106A with the next available agent device. Additionally, the software executable instructions may cause the call center device 120 to change the call status for the inbound call from an unassigned call status to an assigned call status. In some embodiments, the call center device 120 may change the call status for the inbound call to an assigned call status even if the inbound call is still within the active queue. In doing so, the call analysis circuitry 208 will not identify or determine the active inbound call session again, thus ensuring computational resource efficiency. The active inbound call session may then proceed as normal with the agent and agent device.

If the user device is eligible for a cross-channel interaction session, the process proceeds to operation 410. As shown by operation 410, the apparatus 200 includes means, such as call analysis circuitry 208 or the like, for determining a caller inquiry. If the call analysis circuitry 208 determines the user device 106A is eligible for the cross-channel interaction session, this may be indicative that the user device 106A is capable of establishing communication across a digital channel and/or the user has enabled communications with user device 106A that are necessary to establish communication across a digital channel. Thus, the call analysis circuitry 208 may determine that the user device 106A is capable of facilitating communication over a digital channel. Prior to establishing or prompting the user device 106A to establish communication over the digital channel, the call analysis circuitry 208 may further determine the caller inquiry. The caller inquiry may refer to a reason for the active inbound call session. As described in more detail in operation 412, the caller inquiry needs to be determined to subsequently determine whether the digital channel is capable of resolving the caller inquiry.

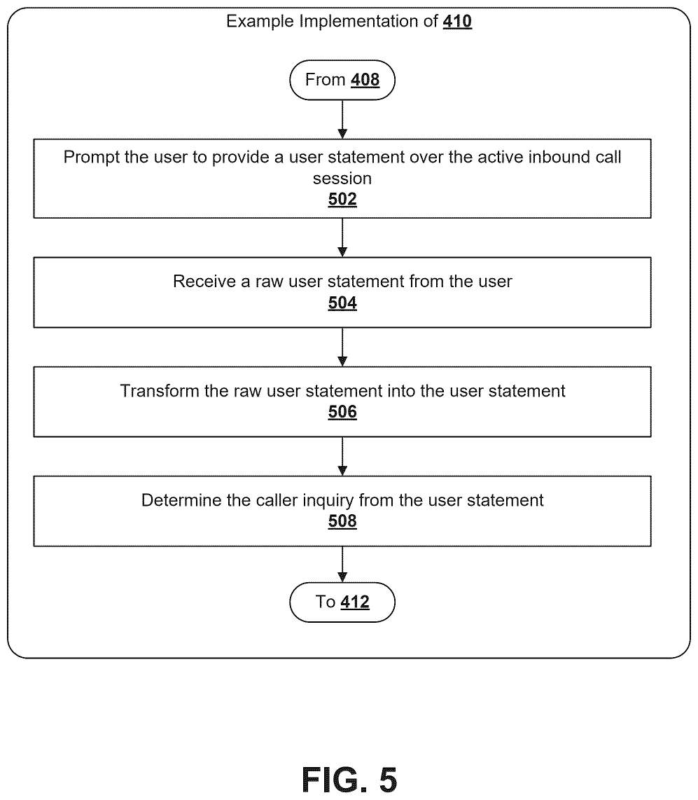

In some embodiments, operation 410 may be performed in accordance with the operations described by FIG. 5. Turning now to FIG. 5, example operations are shown for determining the call inquiry from a user statement.

As shown by operation 502, the apparatus 200 includes means, such as memory 204, communications hardware 206, call analysis circuitry 208, or the like, for prompting the user to provide a user statement over the active inbound call session. In some embodiments, the user may provide a raw user statement over the voice channel and this raw user statement may be transformed into a user statement that can then be used to determine the caller inquiry. In some embodiments, the call analysis circuitry 208 may be configured with a standard prompt to select for the active inbound call session.

In some embodiments, the standard prompt may be stored in an associated memory, such as in memory 204. The call analysis circuitry 208 may access the standard prompt from the associated memory and use the communications hardware 206 to provide the prompt to the call center device 120. In some embodiments, the standard prompt may include software executable instructions that cause the call center device 120 to generate audio over the voice channel. For example, the standard prompt may include instructions to output audio of “can you please provide a brief statement of the reason for your call today?” In some embodiments, the call center device 120 may be configured with a speech-to-text (STT) module that may use the text included in the prompt to generate the audio. The user on the user device 106A may listen to the produced audio and thus, may be prompted to provide a user statement.

In some embodiments, the call analysis circuitry 208 may select a standard prompt from memory based on the user account associated with the user. In particular, in some embodiments, one or more standard prompts may be stored in an associated memory, such as memory 204, and each standard prompt may correspond to a particular language. In some embodiments, a user account for the user may include a user language preference for the user. Prior to selecting the standard prompt from memory, the call analysis circuitry 208 may identify the user language preference from the user account and then may select the standard prompt that corresponds to a language indicated by the user language preference.

As shown by operation 504, the apparatus 200 includes means, such as communications hardware 206 or the like, for receiving a raw user statement from the user. In some embodiments, the standard prompt may further include computer executable instructions to listen for audio from the user device once the standard prompt is provided. The call center device 120 may provide received audio to the communications hardware 206. In some embodiments, the communications hardware 206 may receive live audio of a raw user statement received from the call center device 120. In some embodiments, the communications hardware 206 may be configured to collect audio of the raw user statement from the user over a time limit and then provide the entire audio file to the communications hardware 206.

Additionally, or alternatively, in some embodiments, the communications hardware 206 may receive the raw user statement from the user device 106A. In particular, in an instance in which the user is currently logged into a user account within the mobile application associated with apparatus 200, the user device 106A may be configured to provide the raw user statement to the communications hardware 206. To do so, the communications hardware 206 may provide a request or instruct the mobile application executing on the user device 106 to collect audio after or simultaneously with the prompt to the user to provide the user statement, as described in operation 502. In response, the mobile application may record audio of the raw user statement and provide it to the communications hardware 206, such that the communications hardware 206 receives the raw user statement from the user device 106A via the mobile application.

A raw user statement may be formatted as an audio file, such as a waveform audio file format (WAV), a G.711 format, a G.729 format, an MP3 format, a Voxel format (VOX), and/or the like. The raw user statement may correspond to the user's described reason for the call. For example, the raw user statement may be an audio file of the user saying, “I'm having issues with my debit card.”

As shown by operation 506, the apparatus 200 includes means, such as call analysis circuitry 208 or the like, for transforming the raw user statement into the user statement. Once the communications hardware 206 has received the raw user statement, the call analysis circuitry 208 may transform the raw user statement into a user statement. A user statement may be formatted in a standardized file format, such as a text file, and thus may be subsequently processed by the call analysis circuitry 208 to determine the caller inquiry. In some embodiments, the call analysis circuitry 208 may use a transformation model to transform the raw user statement into the user statement.

In some embodiments, the transformation model may be a machine learning model. In particular, the transformation model may be an automatic speech recognition (ASR) model that may use speech-to-text techniques to convert the raw user statement into the user statement. The transformation model may be using a supervised learning process, where the transformation model is provided various audio recordings along with the corresponding text transcript. The transformation model may thus be trained to accurately map spoken words to text. Additionally, the transformation model may be configured to apply various audio processing techniques, such as noise reduction algorithms, echo cancellation algorithms, speech enhancement algorithms, automatic gain control algorithms, speech segmentation algorithms, dereverberation algorithms, and/or the like. Additionally, in some embodiments, the transformation model may be trained to automatically detect a spoken language from the raw user statement and format the user statement in either the corresponding language or in a default language (as set by an authorized agent). The transformation model may be trained to detect language by including labelling the audio recordings and transcripts with the appropriate language category. Thus, the transformation model may be trained to convert audio files to high fidelity text transcriptions.

The call analysis circuitry 208 may provide the raw user statement to the transformation model and the transformation model may process the raw user statement to transform it into a user statement. The transformation model may process the raw user statement and may apply the above-described audio processing techniques if required. In some embodiments, the transformation model may further identify the language spoken in the raw user statement and may output a text transcription (e.g., the user statement) in a corresponding language. Alternatively, the transformation model may output a text transcription (e.g., the user statement) in a default language. Once the transformation model has processed the raw user statement and transformed it to the user statement, the transformation model may output the user statement to the call analysis circuitry 208.

As shown by operation 508, the apparatus 200 includes means, such as memory 204, call analysis circuitry 208 or the like, for determining the caller inquiry from the user statement. As described above, the call analysis circuitry 208 may determine the caller inquiry from the user statement. In some embodiments, a caller inquiry may be a categorical value that corresponds to a set of defined caller inquiry categories. The caller inquiry categories may be stored in an associated memory, such as memory 204.

In some embodiments, each category of caller inquiries may be associated with a set of keywords. In some embodiments, keywords for a given caller inquiry category are predefined by an authorized agent. In some embodiments, the call analysis circuitry 208 may be configured to identify keywords included in the user statement and then compare these keywords to the keywords associated with each caller inquiry category. The call analysis circuitry 208 may be configured to select the caller inquiry category based on a similarity of keyword matches between a particular caller inquiry category and the user statement. For example, the call analysis circuitry 208 may be configured to select a caller inquiry category that includes the greatest number of keywords that also appear in the user statement.

Alternatively, in some embodiments, the call analysis circuitry 208 may be configured to use the call analysis model to determine the caller inquiry. The call analysis model may be a machine learning model, such as a recurrent neural network or a large language model, that may be configured to process the user statement, determine the caller inquiry, and output the caller inquiry to the call analysis circuitry 208. The call analysis model may be trained using supervised learning techniques. In particular, the call analysis model may be provided various historical user statements that are labelled with a caller inquiry category, as determined by a subject-matter expert. The call analysis model may learn to recognize patterns, modifiers, context, etc. associated with particular keywords within the user statement and associate these patterns or auxiliary text with a particular caller inquiry category. The call analysis model may thus learn to identify common keywords within user statements and learn to identify patterns and context common within user statements of a particular caller inquiry category.

The call analysis circuitry 208 may provide the user statement to the call analysis model and the call analysis model may process the user statement. In some embodiments, the call analysis model may identify keywords within the user statement and further evaluate the surrounding context, modifiers, or patterns of other terms surrounding a keyword. The call analysis model may be configured to generate a similarity score for one or more caller inquiry categories. The similarity score may be a numerical value within a predefined range (0 to 100) that is representative of the inferred similarity between the text of the user statement as compared to the representative text of historical user statements for a given caller inquiry category. The call analysis model may identify keywords or phrases within the current user statement that also appear within representative text of historical user statements associated with a particular caller inquiry category. The call analysis model may be configured to select the call inquiry category based on the similarity score. For example, the call analysis model may be configured to select the call inquiry category that is associated with the high or best similarity score as the caller inquiry for the user statement. Once the call analysis model has selected the caller inquiry category, the call analysis model may output the caller inquiry category to the call analysis circuitry 208. The call analysis circuitry 208 may then determine the caller inquiry as the caller inquiry category output by the call analysis model.

In some embodiments, certain caller inquiry categories may have a hierarchical relationship with other caller inquiry categories. For example, a caller inquiry category of “debit card issues” may be a top-most or broader category and may be associated with second-level or narrower caller inquiry categories of “lost debit card,” “stolen debit card,” “debit card never received,” “change debit card PIN,” or “freeze debit card.” The call analysis circuitry 208 may proceed to operation 412 regardless of the level of the caller inquiry determined but the hierarchical level of the caller inquiry may inform the contextual conversation data generated by the digital channel circuitry 210.

Returning now to FIG. 4, as shown by operation 412, the apparatus 200 includes means, such as memory 204, call analysis circuitry 208, or the like, for determining whether the digital channel interaction is capable of resolving the caller inquiry. As described above, the caller inquiry is categorical value that may describe a reason for the active inbound call session. The call analysis circuitry 208 may be configured to determine whether the digital channel is capable of resolving the caller inquiry. If the digital channel is capable of resolving the caller inquiry, then the call analysis circuitry 208 may proceed to establishing communication with the user device 106A over the digital channel and/or prompting the user device 106A to establish communication over the digital channel. However, if the digital channel is not capable of resolving the caller inquiry, the call analysis circuitry may conserve computational resources and instead, cause the active inbound call session to be assigned to an agent and/or agent device.

For example, certain caller inquiries may require human agent assistance and therefore are not suitable to be handled using a digital channel. Therefore, the call analysis circuitry 208 may first determine the caller inquiry and whether the caller inquiry is capable of being resolved over the digital channel before additional communications with user device 106A to establish communication over a digital channel are provided. This allows for computational resources to be conserved for both apparatus 200 and user device 106A as well as a reduction in overall network bandwidth. Furthermore, as described further below, the determination of whether the caller inquiry is capable of being resolved within the digital channel requires minimal interaction from the user and allows for a more seamless and pleasant user experience.

As described above, in some embodiments, a caller inquiry may be categorical value that corresponds to a particular category of defined caller inquiry categories. The caller inquiry categories may be stored in an associated memory, such as memory 204. In some embodiments, each caller inquiry category may be associated with an indicator of whether or not the particular caller inquiry can be resolved over a digital channel. For example, a caller inquiry category may include a digital category flag that indicates the caller inquiry category is suitable for handling over the digital channel. By way of particular example, a caller inquiry category of “debit card issues” may be associated with a digital category flag. The call analysis circuitry 208 may thus determine the “debit card issues” caller inquiry category is associated is capable of being resolved over the digital channel. As another example, a caller inquiry category of “transaction fraud inquiry” may not be associated with a digital category flag. Thus, the call analysis circuitry 208 may determine the “transaction fraud inquiry” caller inquiry category is not capable of being resolved of the digital channel and should instead, be resolved over the voice channel.

If the digital channel interaction is not capable of resolving the caller inquiry, the process proceeds to operation 408, as described above. In this instance, even if the user device 106A is determined to be eligible for the cross-channel interaction session, the active inbound call session may still be assigned to an agent because the caller inquiry is not suitable to be handled over the digital channel.

If the digital channel interaction is capable of resolving the caller inquiry, the process proceeds to operation 414. As shown by operation 414, the apparatus 200 includes means, such as digital channel circuitry 210 or the like, for generating contextual conversation data. The digital channel circuitry 210 may be configured to generate the contextual conversation data for the digital channel. In particular, the digital channel circuitry 210 may generate the contextual conversation data based on the caller inquiry. The contextual conversation data may include relevant prompts, questions, confirmations, and/or the like for the user that are responsive to the caller inquiry. For example, if the caller inquiry was “I'm having issues with my debit card”, the contextual conversation data may include a prompt that asks the user to confirm that this is the caller inquiry they are calling about.

In some embodiments, the digital channel circuitry 210 may use a conversation generation model to generate the contextual conversation data. In some embodiments, the conversation generation model may be a large language model that is trained to process a caller inquiry, generate contextual conversation data, and output the contextual conversation data to the digital channel circuitry 210. In some embodiments, the conversation generation model may be trained using an initial large language model. The initial large language model may be a stock or template large language model that is further trained or refined by providing the initial large language model with conversational transcripts from a training corpus. The weights for various parameters in the initial large language model may be updated based on processing the training corpus and the resulting model with the updated weights may be the conversation generation model. The conversational transcripts may include conversations between a user and an agent, and the conversation generated model may be trained to recognize text and response patterns in the exchanges between a user and agent within these conversational transcripts. In particular, the conversation generation model may be trained to mimic agent responses and dialogue.

In some embodiments, the conversation generation model may be configured to adhere to a general script that is associated with a particular caller inquiry category. For example, each caller inquiry category may be associated with a general script that may provide the conversation generation model with an outline for the contextual conversation data. The conversation generation model may additionally customize the general script using the user information included in the user account associated with the user. For example, the conversation generation model may greet the user using a preferred name indicated in the user account.

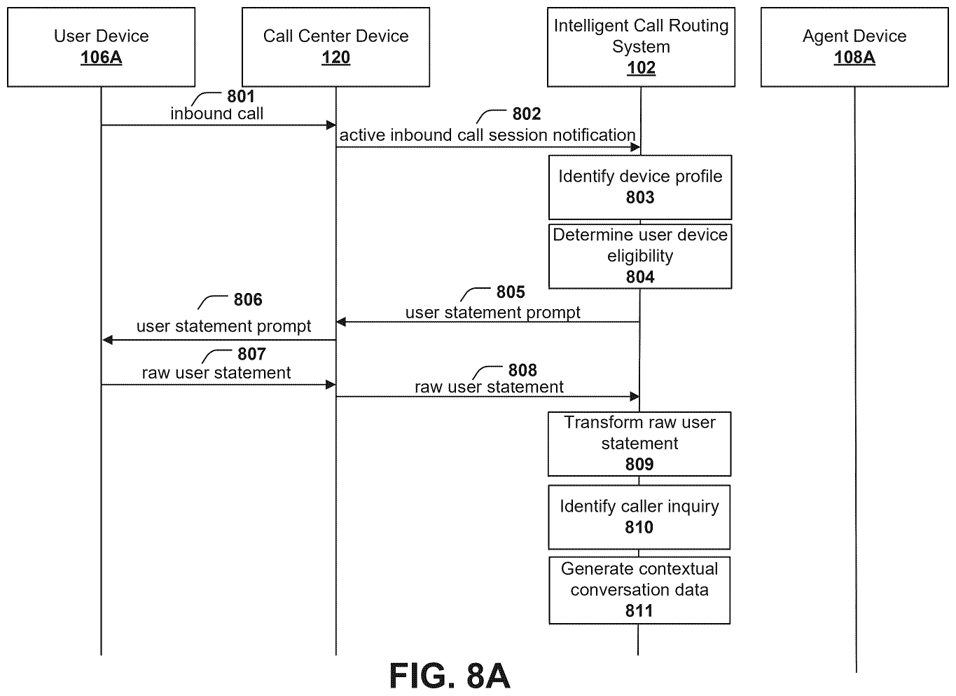

In some embodiments, the contextual conversation data may be generated based on the caller inquiry category to which the caller inquiry corresponds. As described above, a caller inquiry category may have a hierarchical relationship with one or more other caller inquiry categories. By way of continuing example, a caller inquiry category of “debit card issues” may be a top-most or broader category and may be associated with second-level or narrower caller inquiry categories of “lost debit card,” “stolen debit card,” “debit card never received,” “change debit card PIN,” or “freeze debit card.” In some embodiments, caller inquiry categories that are associated with the lowest or most narrow hierarchical level may be associated with one or more resolution instruction operations. For example, for a “lost debit card” caller inquiry category may be associated with resolution instructions of confirming a user's mailing address, updating a user's mailing address if required, and causing a new debit card to be ordered for the user account and shipped to the user's mailing address. As described in more detail in FIG. 7, once these resolution instructions have been completed, the digital channel circuitry 210 may determine the caller inquiry is resolved.

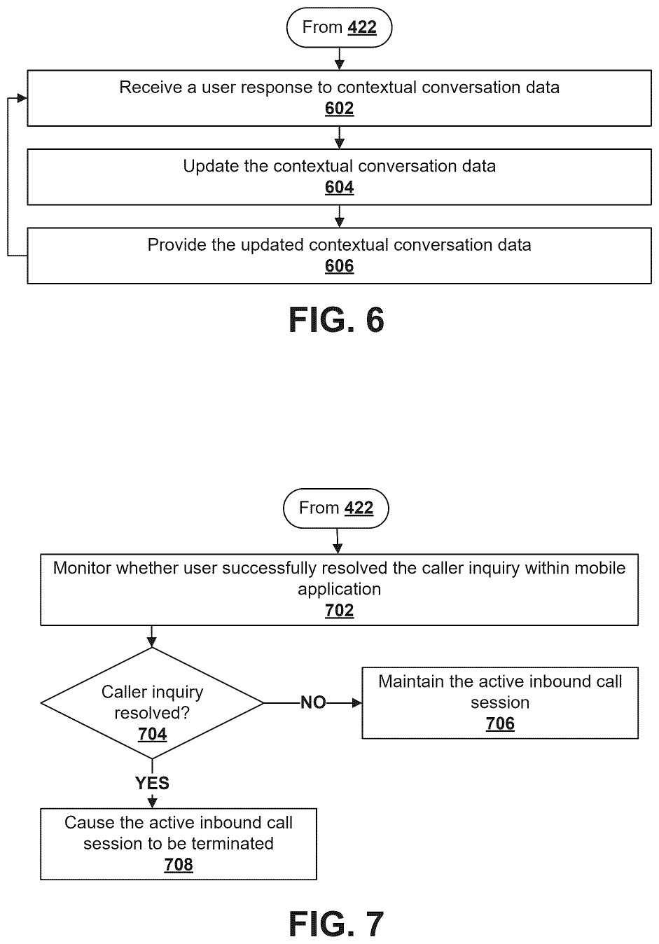

In some embodiments, the conversation generation model may be configured with the caller inquiry categories and associated hierarchical relationships. As described in further detail in FIG. 6, if the caller inquiry determined in operation 410 is not at a lowest hierarchical level, then the conversation generation model may be trained to ask questions and/or prompt the user to solicit additional information to refine a broader caller inquiry category to reach a caller inquiry category at an associated lowest hierarchical level. In some embodiments, the conversation generation model may utilize the call analysis model to determine an updated caller inquiry for the user based on a user response. Alternatively, the conversation generation model may also be configured to determine an updated caller inquiry based on a caller response.

Once the conversation generation model has generated the contextual conversation data, it may output this contextual conversation data to the digital channel circuitry 210. In some embodiments, the digital channel circuitry 210 may store this contextual conversation data in the user account of the user for a limited time. If the user accesses his/her user account on user device 106A via the associated mobile application, this contextual conversation data may automatically be provided to the user device.

As shown by operation 416, the apparatus 200 includes means, such as communications hardware 206, digital channel circuitry 210, authentication circuitry 212, or the like, for providing the contextual conversation data over the digital channel. In some embodiments, the digital channel circuitry 210 may cause the communications hardware 206 to provide a digital channel prompt to user device 106A. The digital channel prompt may include a link or hyperlink to a particular endpoint within the associated mobile application, which may serve as the digital channel. The endpoint may include the contextual conversation data. In some embodiments, the contextual conversation data may be provided within the mobile application in a conversational format, such as a chatbot. This conversational or chatbot format may allow the user to provide a user response to the contextual conversation data.

The digital channel prompt may be provided to the user device as a text message, an email, a mobile application prompt, and/or the like. In some embodiments, the communications hardware 206 may provide the digital prompt using a hypertext transfer protocol (HTTP) or HTTP secure (HTTPS) protocol. In some embodiments, the communications hardware 206 may use specific application program interfaces (APIs), such as representational state transfer APIs (RESTful APIs) or WebSocket APIs to provide the digital channel prompt to the mobile application on the user device 106A.

The digital channel prompt may request that the user login to the mobile application into the mobile application if the user is not already logged in. If the user is already logged in to the user account within the mobile application, interaction with the digital channel prompt may cause the user device 106A to be open or otherwise be directed to the endpoint within the mobile application such that the contextual conversation data is displayed to the user within the mobile application. If the user is not yet logged in to a user account, interaction with the digital channel prompt may cause the user device 106A to open a login page for the user account and further prompt the user to provide a user identifier and user identifiers.

Whether in response to the digital channel prompt or independent of the digital channel prompt, the communications hardware 206 may receive a login request from the user device 106A. The login request may include a candidate user identifier and candidate user credentials. In some embodiments, authentication circuitry 212 may perform an authentication routine to authenticate the logon request for user account as received from the user device 106A. The authentication circuitry 212 may authenticate the logon request received from user device 106A based on the received candidate user credentials and stored user credentials associated with the user account. In particular, the authentication circuitry 212 may use the candidate user identifier to determine associated stored user credentials. If each of the received candidate user credentials sufficiently match the corresponding stored user credentials, the authentication circuitry 212 may successfully authenticate the user and the logon request. Alternatively, if the received candidate user credentials fail to sufficiently match the stored user credentials, the authentication circuitry 212 may fail to authenticate the user and the logon request. For example, for a candidate user credential that is a password, the authentication circuitry 212 may use a hashing function to hash the characters of the candidate password and then compare the hashed candidate password to a hashed stored password. In an instance in which the corresponding characters of the hashed candidate password and hashed stored password exactly match, the authentication circuitry 212 may determine the candidate user credentials sufficiently match the stored user credentials.

In some embodiments, the authentication circuitry 212 may use one or more models to determine whether the candidate user credentials sufficiently match the stored user credentials. For example, in an instance in which a candidate user credential corresponds to biometric data (e.g., fingerprint data, facial image data, retina data, or the like), the authentication circuitry 212 may be configured to use one or more biometric matching machine learning models to determine whether a similarity score between biometric data of the candidate user credential and corresponding biometric data of the stored user credential. In an instance in which the similarity score satisfies one or more similarity thresholds, the authentication circuitry 212 may determine that the candidate user credential sufficiently matches the stored user credential. Once the user has successfully logged into an associated user account within the mobile application, the user may access the contextual conversation data.

Optionally, as shown by operation 418, the apparatus 200 includes means, such as communications hardware 206, digital channel circuitry 210 or the like, for monitoring a user activity level within the mobile application. In some embodiments, the digital channel circuitry 210 may be configured to monitor a user activity level within the mobile application. By monitoring the user activity level, the digital channel circuitry 210 may identify potential issues the user is experiencing with the mobile application, the contextual conversation data, or with using the digital channel to resolve their caller inquiry. The communications hardware 206 may monitor for or otherwise receive user activity updates from the user device 106A. For example, the user activity updates may include any user activity the user has performed within the mobile application such as any interaction with the contextual data, any provided responses to the contextual conversation data, any pages or endpoints visited within the mobile application, any interaction with page elements, and/or the like.

Optionally, as shown by operation 420, the apparatus 200 includes means, such as digital channel circuitry 210 or the like, for determining whether the user activity level satisfies engagement requirements. The digital channel circuitry 210 may determine whether the user activity level within the mobile application satisfies one or more engagement requirements. An engagement requirement may define criteria for a sufficient interaction level and/or set various time limits for said criteria. For example, an engagement requirement may require the user to be successfully logged into an associated user account in the mobile application within 2 minutes of providing the digital channel prompt. As another example, an engagement requirement may require that the user activity level indicate that the user has successfully navigated to endpoint that is associated with the contextual conversation data within 2 minutes.

If the user activity level fails to satisfy the engagement requirement, the process proceeds to operation 408, as described above. In this instance, the digital channel circuitry 210 may infer that the user may be experiencing difficulties with accessing the digital channel or resolving their caller inquiry using the digital channel. Thus, the digital channel circuitry 210 may provide an alert to the call analysis circuitry 208 and in turn, the call analysis circuitry 208 may cause the active inbound call session to be assigned to an agent. In some embodiments, the call analysis circuitry 208 may proceed to operation 408 even if the user activity level satisfies engagement requirements. In particular, the endpoint associated with the contextual conversation data may include an option for the user to request to speak with an agent. If the user interacts with this interaction element, the communications hardware 206 may receive a user request to speak with an agent. The call analysis circuitry 208 may then cause the active inbound call session to be assigned to an agent in response to the user request to speak with an agent.

In some embodiments, even if the active call session is assigned to an agent, the digital channel with user device 106A may be maintained and may thereby allow for the user to respond to the agent using either the voice channel or the digital channel. In an instance in which the active inbound call session is assigned to an agent associated with agent device 108A and the communications hardware 206 receives a user response over the digital channel, the communications hardware 206 may provide the user response to the agent device 108A. In this way, the cross-channel interaction session may allow the user to resolve his/her caller inquiry using the voice channel as well as the digital channel. Use of such a digital channel may provide for enhanced security, such as when the user may need to provide sensitive user information to the agent.

If the user activity level satisfies the engagement requirement, the process proceeds to operation 422. As shown by operation 422, the apparatus 200 includes means, such as communications hardware 206, call analysis circuitry 208, or the like, for causing the call status to remain unassigned. If the digital channel circuitry 210 determines the user activity level has satisfied the one or more engagement requirements, the digital channel circuitry 210 may cause the call status for the active inbound call session to remain unassigned. Thus, inbound call from user device 106A may not be assigned to an agent for a limited time period and instead, the user may attempt to resolve their caller inquiry using the digital channel.

In some embodiments, the call analysis circuitry 208 may use communications hardware 206 to provide software executable instructions to the call center device 120 that causes the call center device 120 to maintain the unassigned status for the active inbound call session with user device 106A. In response to these instructions, the call center device 120 may cause the active inbound call session with user device 106A to remain unassigned. In some embodiments, the software executable instructions may further define a limited time period for which the active inbound call session should remain unassigned. For example, the software executable instructions may define a limited time period of 10 minutes. Thus, the call center device 120 may keep the call status of the active inbound call session as unassigned for a period of 10 minutes after which the call center device 120 may assign the active inbound call session to an agent. Thus, the user may be given an opportunity to resolve their caller inquiry using the digital channel but if they are unsuccessful after the limited time period, they may be directed to an agent who can then assist the user with resolving their caller inquiry using the voice channel. Alternatively, the software executable instructions may require the call center device 120 to keep the active inbound call session as unassigned unless additional software executable instructions are received from the communications hardware 206 and authorize call center device 120 to assign the active inbound call session to an agent.

Turning now to FIG. 6, example operations are shown for providing updated contextual conversation data. As shown by operation 602, the apparatus 200 includes means, such as communications hardware 206, call analysis circuitry 208, or the like, for receiving a user response to the contextual conversation data. As described in FIG. 4, the contextual conversation data may be provided in a conversational or chatbot format and the user may be prompted to provide a user response to the contextual conversation data. By way of continuing example, the contextual conversation data provided to the user device 106A in operation 416 may be “on the phone call, you indicated ‘I'm having issues with my debit card.’ Is that correct?” This may prompt the user to respond to the contextual conversation data with “yes” if that is what he/she indicated on the phone call or “no” if that was not what he/she indicated on the phone call. The communications hardware 206 may receive a user response to the contextual conversation data from user device 106A within the mobile application.

If the user response is received over the digital channel, the communications hardware 206 may receive the user response using a HTTP or HTTPS protocol or may receive the user response using specific APIs, such as RESTful APIs or WebSocket APIs.

Additionally, or alternatively, the communications hardware 206 may receive a user response to the contextual data over the voice channel. The communications hardware 206 may be configured to detect, monitor, or otherwise receive a raw user response from the user device 106A over the voice channel or the digital channel. The raw user response may be formatted as an audio file in a similar manner as the raw user statement described in operation 504 of FIG. 5. If the user provides a user response over the voice channel, the call center device 120 may provide the received audio from the user to the communications hardware 206. In turn, call analysis circuitry 208 may be configured to transform the raw user response into the user response in a substantially similar manner as described in operation 506 of FIG. 5.

As shown by operation 604, the apparatus 200 includes means, such as digital channel circuitry 210 or the like, for updating the contextual conversation data. The digital channel circuitry 210 may receive the user response to the contextual conversation data from the communications hardware 206 and may further update the contextual conversation data. The digital channel circuitry 210 may use the conversation generation model to update the contextual conversation data in a substantially similar manner as described in operation 414 of FIG. 4.

For example, the user response may be “yes” to the contextual conversation data of “on the phone call, you indicated ‘I'm having issues with my debit card.’ Is that correct?” Here, the user response may provide confirmation of the caller inquiry indicated by the contextual conversation data. The conversation generation model may then update the contextual conversation data to further refine a caller inquiry category to a lowest level caller inquiry category available. For example, the conversation generation model may update the contextual conversation data to “thanks for confirming. Could you tell us more about this issue? You can supply this information over the phone or in the app.” In some embodiments, the conversation generation model may update the contextual conversation data by following the general script that is associated with a particular caller inquiry category.

As described in FIG. 4, the conversation generation model may be configured with the caller inquiry categories and associated hierarchical relationships. Thus, the contextual conversation data provided to the user may prompt the user to provide additional information to identify a caller inquiry category at an associated lower hierarchical level as compared to the current caller inquiry category. Therefore, the user response provided in operation 602 may provide information that may allow the conversation generation model to determine an updated caller inquiry category based on the user response. By way of continuing example, if the user response was “yes” to the contextual conversation data of “on the phone call, you indicated that you lost your debit card. Is that correct?”, then the conversation generation model may determine a caller inquiry of “lost debit card.” The conversation generation model may analyze the user response to determine an updated caller inquiry category of “lost debit card.” In some embodiments, the conversation generation model may use the call analysis model to determine the updated caller inquiry category.

Once a lowest or narrowest caller inquiry category has been determined, the digital channel circuitry 210 may perform one or more operations associated with the caller inquiry category. By way of continuing example, a “lost debit card” caller inquiry category may be a lowest hierarchical level and is therefore associated with one or more resolution instruction operations. The resolution instructions may include confirming a user's mailing address, updating a user's mailing address if required, and causing a new debit card to be ordered for the user account and shipped to the user's mailing address. In some embodiments, the conversation generation model may further generate contextual conversation data as required by a script or as required due to the resolution instructions. For example, the conversation generation model may update the contextual conversation data to “The address we have on file at 123 Main St., Magnolia, NH 12345. Is that correct?” in order to confirm the user's mailing address as required by the resolution instructions. The digital channel circuitry 210 may cause a new debit card to be ordered to the mailing address for the user account once the user has provided a user response that confirms the address or provides a new mailing address.

As shown by operation 606, the apparatus 200 includes means, such as communications hardware 206, digital channel circuitry 210, or the like, for providing the updated contextual conversation data. Once the digital channel circuitry 210 has updated the contextual conversation data, the digital channel circuitry 210 may cause the communications hardware 206 to update the endpoint to reflect the updated contextual conversation data. Thus, the user may view the updated contextual conversation data within the mobile application using user device 106A.

The updated contextual conversation data may be provided to the mobile application on user device 106A using a HTTP or HTTPS protocol. In some embodiments, the communications hardware 206 may use specific APIs, such as RESTful APIs or WebSocket APIs to provide the updated contextual conversation data to the mobile application on the user device 106A.

Once the updated contextual conversation data has been provided by the communications hardware 206, the communications hardware 206 may continue to monitor for a user response over the digital channel or voice channel. If a user response is received, operations 602-606 described in FIG. 6 may be repeated. The communications hardware 206 may monitor, detect, and/or receive a user response to the updated contextual conversation data over the digital channel (e.g., within the mobile application) or over the voice channel (e.g., as received from the call center device 120).

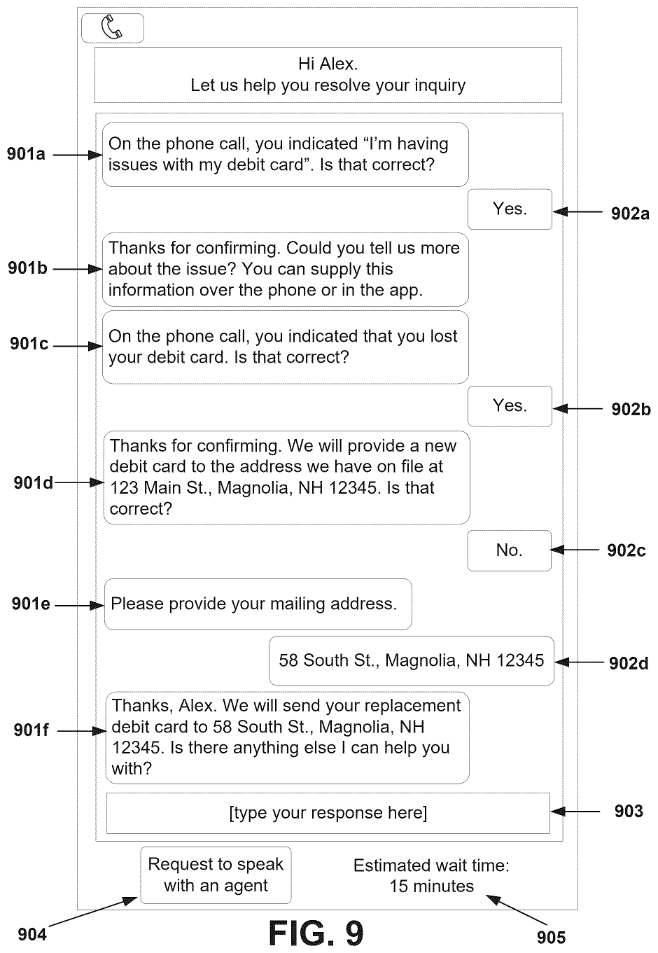

Turning to FIG. 9, a graphical user interface (GUI) is provided that illustrates a user interaction over a digital channel during a cross-channel interaction session. The GUI shown in FIG. 9 may be displayed to the user by the user device 106A within the associated mobile application. As shown in FIG. 9, the mobile application may display the contextual conversation data 901a, 901b, 901c, 901d, 901e, and 901f and the received user responses 902a, 902b, 902c, and 902d. The GUI may further include user interaction element 903 that the user may use to enter a user response using the digital channel. Alternatively, the user may speak into a receiver of the user device 106A to provide a user response over the voice channel. Additionally, the GUI may include user interaction element 904 that the user may interact with (e.g., click, touch, or otherwise select) to automatically cause the communications hardware 206 to receive a user request to speak with an agent. This may cause the call analysis circuitry 208 to cause the active inbound call session to be assigned to an agent. The GUI may further include an estimated wait time 905 that is indicative of the wait time for a next available agent should the user wish to speak with an agent.

Turning now to FIG. 7, example operations are shown for determining whether a caller inquiry has been resolved. As shown by operation 702, the apparatus 200 includes means, such as communications hardware 206, digital channel circuitry 210, or the like, for monitoring whether the user has successfully resolved the caller inquiry within the mobile application. As described above, in some embodiments, the digital channel circuitry 210 may perform operations associated with resolution instructions and may update a user account to indicate that the caller inquiry has been resolved. In some embodiments, the digital channel circuitry 210 may further use the communications hardware 206 to request confirmation from the user if this resolved his/her caller inquiry and/or whether he/she had additional caller inquiries. If the user has additional caller inquiries, operations 410-422 may be repeated to handle the additional caller inquiry. Otherwise, the digital channel circuitry 210 may determine the caller inquiry was successfully resolved.

As shown by operation 704, the apparatus 200 includes means, such as digital channel circuitry 210 or the like, for determining whether the caller inquiry has successfully been resolved. The digital channel circuitry 210 may determine whether the caller inquiry has been resolved using the user account, which may include an indication of whether the caller inquiry has been resolved.

If the caller inquiry has not been resolved, the process proceeds to operation 706. As shown by operation 706, the apparatus 200 includes means, such as digital channel circuitry 210, or the like for maintaining the active inbound call session. If the caller inquiry has not yet been resolved, the digital channel circuitry 210 may determine the active inbound call session should be maintained. Thus, the user device 106A may remain connected to apparatus 200 over the voice channel. This may allow the user to provide additional user responses to resolve the caller inquiry and/or if needed, may allow the active inbound call session to be assigned to an agent. To maintain the inbound call session, the digital channel circuitry 210 need not perform additional actions.

If the caller inquiry has been successfully resolved, the process proceeds to operation 708. As shown by operation 708, the apparatus 200 includes means, such as communications hardware 206, digital channel circuitry 210, or the like, for causing the active inbound call session to be terminated. If the digital channel circuitry 210 determines the caller inquiry has been resolved, the digital channel circuitry 210 may cause the active inbound call session over the voice channel to be terminated. To do so, the digital channel circuitry 210 may provide software executable instructions to the call center device 120 and the software executable instructions may cause the call center device 120 to disconnect or hang-up with the user device 106A, thereby terminated the active inbound call session. The software executable instructions may further include instructions to play an audio that concludes the active inbound call session with the user. For example, the call center device 120 may play audio that describes that the caller inquiry has been resolved using the cross-channel interaction and the voice channel will be disconnected.

FIGS. 4-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices that perform the specified functions, or combinations of special purpose hardware and software instructions.

### Example System Interaction

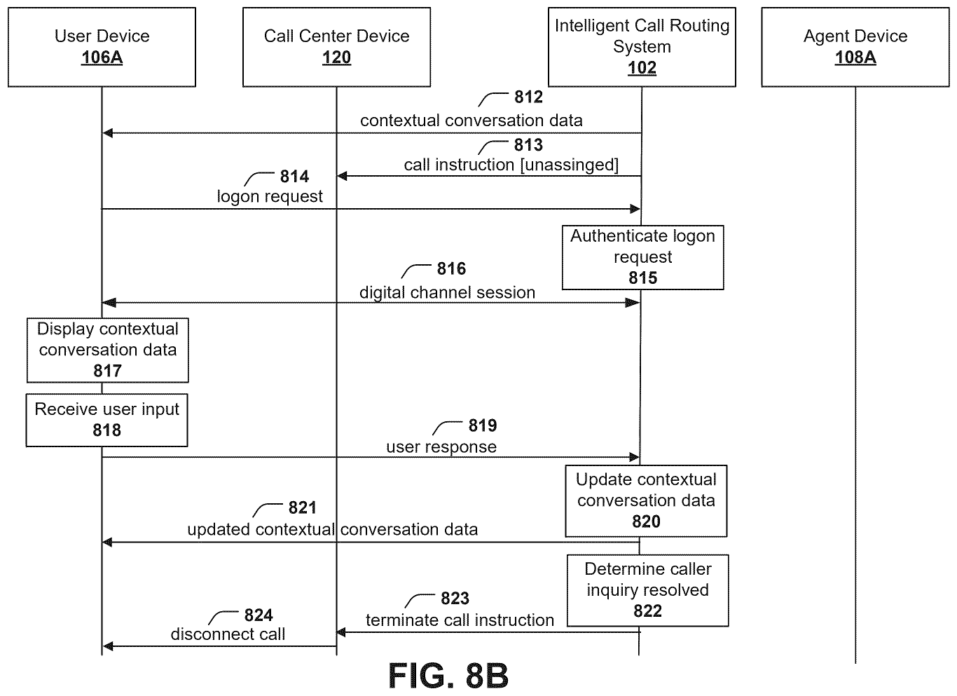

FIGS. 8A and 8B show swim lane diagrams illustrating example operations (e.g., as described above in connection with FIGS. 4-7) performed by components of the environment depicted in FIG. 1 to produce various benefits of the implementations described herein. The operations shown in the swim lane diagram performed by a user device (e.g., any one of user devices 106A-106N) are shown along the line extending from the box labeled “user device 106A”, operations performed by intelligent call routing system 102 are shown along the line extending from the box labeled “intelligent call routing system 102”, operations performed by an agent device (e.g., any one of agent devices 108A-108N) are shown along the line extending from the box labeled “agent device 108A”, and operations performed by a call center device (not shown in FIG. 1) are shown along the line extending from the box labeled “call center device 120”. Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 8A-8B.

Turning first to FIG. 8A, at operation 801, the user device 106A may initiate an inbound call with the call center device 120. At operation 802, the call center device may provide an active inbound call session notification to the intelligent call routing system 102. At operation 803, the intelligent call routing system 102 may identify a device profile associated with user device 106A. At operation 804, the intelligent call routing system 102 may determine whether the user device is eligible for the cross-channel interaction session. If the user device 106A is determined to be eligible for the cross-channel interaction session, at operation 805, the intelligent call routing system 102 may provide a user statement prompt the call center device. At operation 806, the call center device 120 may relay or otherwise provide the user statement prompt to the user device 106A. At operation 807, the user device 106A may provide a raw user statement to the call center device 120. At operation 808, the call center device 120 may provide the raw user statement to the intelligent call routing system 102. At operation 809, the intelligent call routing system 102 may transform the raw user statement into the user statement. At operation 810, the intelligent call routing system 102 may identify the caller inquiry from the user statement. At operation 811, the intelligent call routing system 102 may generate the contextual conversation data based on the caller inquiry.

Turning next to FIG. 8B, at operation 812, the intelligent call routing system 102 may provide the contextual conversation data to the user device 106A. At operation 813, the intelligent call routing system 102 may provide a call instruction to keep the active inbound call session as unassigned. At operation 814, the user device 106A may provide a logon request to the intelligent call routing system 102. At operation 815, the intelligent call routing system 102 may authenticate the logon request. At operation 816, a digital channel session may be established between the user device 106A and the intelligent call routing system 102. At operation 817, the user device 106A may display the contextual conversation data. At operation 818, the user device 106A may receive user input within the digital channel. At operation 819. The user device 106A may provide the user response to the intelligent call routing system 102. Alternatively, if the user device 106A received the user response over the voice channel, the user device 106A would provide the user response to the call center device 120 and the call center device 120 would provide the user response to the intelligent call routing system 102. At operation 820, the intelligent call routing system 102 may update the contextual conversation data based on the user response. At operation 821, the intelligent call routing system 102 may provide the updated contextual conversation data to the user device 106A. At operation 822, the intelligent call routing system 102 may determine the caller inquiry has been resolved. At operation 823, the intelligent call routing system 102 may instruct the call center device 120 to terminate the call. At operation 824, the call center device 120 may terminate or disconnect the call with the user device 106A. a

### Conclusion

As described above, example embodiments provide methods and apparatuses that enable improved handing of inbound calls. Example embodiments thus provide tools that overcome the problems faced by conventional methods that experience various resource inefficiencies and do not provide for a cohesive or consistent user experience. By leveraging the security and convenience enabled by mobile applications on a user device, example embodiments allow for users to resolve their user inquiries within the mobile application in a secure manner. Furthermore, example embodiments described herein provide for users to provide user responses to contextual conversation data using the voice channel or digital channel during the cross-channel interaction session, which has been absent from conventional inbound calls. Additionally, by updating contextual conversation data based on the user response that has historically required human (e.g., agent) analysis allows for fast, consistent, and accurate user inquiry resolution to be performed for the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for handling an inbound call, the method comprising:
determining, by call analysis circuitry, an active inbound call session with a user device associated with a user, wherein the active inbound call session is associated with a call status of unassigned;
determining, by the call analysis circuitry, a caller inquiry from a user statement received from the user over a voice channel;
determining, by the call analysis circuitry, whether a digital channel interaction is capable of resolving the caller inquiry;
in an instance in which the caller inquiry is resolvable by the digital channel interaction, generating, by digital channel circuitry, contextual conversation data based on the caller inquiry;
providing, by communications hardware and via a mobile application, the contextual conversation data to the user device over a digital channel; and
causing, by the call analysis circuitry, the call status of the active inbound call session to remain unassigned.

2. The method of claim 1, further comprising:
receiving, by the communications hardware, a user response to the contextual conversation data;
updating, by the digital channel circuitry, the contextual conversation data based on the user response; and
providing, by the communications hardware and via the mobile application, the updated contextual conversation data to the user device.

3. The method of claim 1, further comprising:
monitoring, by the digital channel circuitry, whether the user successfully resolved the caller inquiry within the mobile application; and
in an instance in which the user successfully resolved the caller inquiry, causing, by the call analysis circuitry, the active inbound call session to be terminated.

4. The method of claim 1, further comprising:
monitoring, by the digital channel circuitry, whether a user activity level within the mobile application satisfies an engagement requirement; and
in an instance in which the user activity level fails to satisfy the engagement requirement, causing, by the call analysis circuitry, the active inbound call session to be assigned to an agent.

5. The method of claim 4, wherein the engagement requirement requires the user perform a user action within a time limit.

6. The method of claim 1, wherein the active inbound call session is associated with a device phone number for the user device,
wherein the method further comprises:
determining, by the call analysis circuitry, a device profile associated with the device phone number; and
determining, by the call analysis circuitry and based on the device profile, whether the user device is eligible for a cross-channel interaction session, wherein the caller inquiry is identified in response to determining the device profile is eligible for the cross-channel interaction session.

7. The method of claim 1, further comprising:
prompting, by the communications hardware, the user to provide the user statement over the active inbound call session;
receiving, by the communications hardware, a raw user statement from the user; and
transforming, by the call analysis circuitry, the raw user statement into the user statement.

8. An apparatus for handling an inbound call, the apparatus comprising:
call analysis circuitry configured to:
determine an active inbound call session with a user device associated with a user, wherein the active inbound call session is associated with a call status of unassigned,
determine a caller inquiry from a user statement received from the user over a voice channel, and
determine whether a digital channel interaction is capable of resolving the caller inquiry;
digital channel circuitry configured to, in an instance in which the caller inquiry is resolvable by the digital channel interaction, generate contextual conversation data based on the caller inquiry; and
communications hardware configured to provide, via a mobile application, the contextual conversation data to the user device over a digital channel,
wherein the call analysis circuitry is further configured to cause the call status of the active inbound call session to remain unassigned.

9. The apparatus of claim 8, wherein the communications hardware is further configured to receive a user response to the contextual conversation data,
wherein the digital channel circuitry is further configured to update the contextual conversation data based on the user response,
wherein the communications hardware is further configured to provide, via the mobile application, the updated contextual conversation data to the user device.

10. The apparatus of claim 8, wherein the digital channel circuitry is further configured to monitor whether the user successfully resolved the caller inquiry within the mobile application,
wherein the call analysis circuitry is further configured to, in an instance in which the user successfully resolved the caller inquiry, cause the active inbound call session to be terminated.

11. The apparatus of claim 8, wherein the digital channel circuitry is further configured to monitor whether a user activity level within the mobile application satisfies an engagement requirement,
wherein the call analysis circuitry is further configured to, in an instance in which the user activity level fails to satisfy the engagement requirement, cause the active inbound call session to be assigned to an agent.

12. The apparatus of claim 11, wherein the engagement requirement requires the user perform a user action within a time limit.

13. The apparatus of claim 8, wherein the active inbound call session is associated with a device phone number for the user device,
wherein the call analysis circuitry is further configured to:
determine a device profile associated with the device phone number, and
determine, based on the device profile, whether the user device is eligible for a cross-channel interaction session, wherein the caller inquiry is identified in response to determining the device profile is eligible for the cross-channel interaction session.

14. The apparatus of claim 8, wherein the communications hardware is further configured to:
prompt the user to provide the user statement over the active inbound call session, and
receive a raw user statement from the user,
wherein the call analysis circuitry is further configured to transform the raw user statement into the user statement.

15. A computer program product for handling an inbound call, the computer program product comprising a non-transitory computer-readable storage medium storing software instructions that, when executed by an apparatus, cause the apparatus to:
determine an active inbound call session with a user device associated with a user, wherein the active inbound call session is associated with a call status of unassigned;
determine a caller inquiry from a user statement received from the user over a voice channel;
determine whether a digital channel interaction is capable of resolving the caller inquiry;
in an instance in which the caller inquiry is resolvable by the digital channel interaction, generate contextual conversation data based on the caller inquiry;
provide, via a mobile application, the contextual conversation data to the user device over a digital channel; and
cause the call status of the active inbound call session to remain unassigned.

16. The computer program product of claim 15, wherein the software instructions, when executed, further cause the apparatus to:
receive a user response to the contextual conversation data;
update the contextual conversation data based on the user response; and
provide, via the mobile application, the updated contextual conversation data to the user device.

17. The computer program product of claim 15, wherein the software instructions, when executed, further cause the apparatus to:
monitor whether the user successfully resolved the caller inquiry within the mobile application; and
in an instance in which the user successfully resolved the caller inquiry, cause the active inbound call session to be terminated.

18. The computer program product of claim 15, wherein the software instructions, when executed, further cause the apparatus to:
monitor whether a user activity level within the mobile application satisfies an engagement requirement; and
in an instance in which the user activity level fails to satisfy the engagement requirement, cause the active inbound call session to be assigned to an agent.

19. The computer program product of claim 18, wherein the engagement requirement requires the user perform a user action within a time limit.

20. The computer program product of claim 15, wherein the active inbound call session is associated with a device phone number for the user device,
wherein the software instructions, when executed, further cause the apparatus to:
determine a device profile associated with the device phone number; and determine, based on the device profile, whether the user device is eligible for a cross-channel interaction session, wherein the caller inquiry is identified in response to determining the device profile is eligible for the cross-channel interaction session.
